(19) United States
(12) Patent Application Publication
(10) Pub. No.: US 2011/0252438 A1
(43) Pub. Date: Oct. 13, 2011

(54) METHOD AND SYSTEM FOR COLLECTING AND ANALYZING INTERNET PROTOCOL TELEVISION TRAFFIC

(75) Inventors: Marc Tremblay, Montreal (CA); Eric Melin, Montreal (CA); Louis Brun, Mont-Royal (CA); Audry Larocque, Mont-Royal (CA)

(73) Assignee: Neuralitic Systems, Montreal, QC (CA)

(21) Appl. No.: 12/739,432

(22) PCT Filed: Nov. 5, 2009
(86) PCT No.: PCT/CA2009/001610

§ 371 Date: Apr. 23, 2010

Related U.S. Application Data
(60) Provisional application No. 61/111,449, filed on Nov. 5, 2008.

(51) Int. Cl. H04N 7/173

(52) U.S. Cl. 725/9

(57) ABSTRACT

A method and system for collecting and analyzing IPTV traffic in an IPTV network including end user premises, an access network, and an IP core network, wherein filtering sub-systems are deployed to collect in real time IPTV traffic using at least one access technology. The filtering sub-systems are deployed in at least one location selected from the group consisting of the end user premises, the access network, and the IP core network, and the at least one location of the filtering sub-systems is selected to collect IPTV traffic with a granularity at the level of the end users. The collected IPTV traffic is transmitted from the filtering sub-systems to a centralized analytic system, the collected IPTV traffic is aggretated in relation to the end users, and business intelligence and marketing oriented analysis is performed over the collected IPTV traffic using the centralized analytic system.

### FIELD

The present invention generally relates to Internet Protocol (IP) television (IPTV). More specifically, but not exclusively, the present invention is concerned with a method and system for collecting IPTV traffic distributed over various types of access networks to, for example, analyze this IPTV traffic from a business intelligence perspective.

### BACKGROUND

The IP protocol is increasingly becoming the reference for delivering any type of data over any type of access technology. The most common type of data conveyed over the IP protocol includes web services at large and emails. Such data can be accessed at home via a broadband connection, in the office via a dedicated high speed link, and almost anywhere via a Cellular Operator infrastructure. However, the delivery of such data is more and more considered by end users as a commodity. Thus, there is a huge pressure on the revenues that can be generated from the delivery of such services. At the same time, the revenues generated from traditional voice traffic, be it fixed or mobile, are also under pressure.

As a result, Internet Service Providers (ISPs) and Cellular Operators are deploying new value-added services based on IP technologies, in order to generate new types of revenues. Internet Protocol television (IPTV) constitutes one of these services. Traditional Cable Operators, as well as ISPs, are offering TV services over IP transport, using different types of underlying access technologies (cable, Digital Subscriber Line (DSL), optical fiber, etc.). At the same time, Cellular Operators are also offering IPTV services, as part of a premium service offer over their cellular infrastructure. In the context of the present specification, IPTV must be understood in a broad sense. This includes synchronous diffusion of TV channels to a large number of end users (it will also be referred to as multicast television services); as well as Video (or Television) On Demand services, where a single user asynchronously accesses a specific video content.

The complexity involved with the delivery of IPTV services over different types of access technologies has driven the development of methods and systems to collect IPTV data, in order to analyze the behaviour of different entities involved in the delivery of IPTV services. The data collected are usually used for network management, Quality of Service (QoS) conformance validation, detection of errors and performance analysis.

### BRIEF DESCRIPTION OF THE DRAWINGS

In the appended drawings:

FIG. 1 is a schematic diagram of an example of IPTV network;

FIG. 2 is a schematic diagram of a method and system for collecting and analyzing IPTV traffic;

FIG. 3 is a schematic diagram of the method and system of FIG. 2 applied to a cellular network;

FIG. 4 is a schematic diagram of the method and system of FIG. 2 applied to a broadband network; and

FIG. 5 is a schematic diagram of the method and system of FIG. 2 applied to a converged cellular/broadband network.

### DETAILED DESCRIPTION

According to an illustrative embodiment, there is provided a method for collecting and analyzing IPTV traffic in an IPTV network including end user premises, an access network, and an IP core network, the method comprising:

deploying filtering sub-systems to collect in real time IPTV traffic using at least one access technology, wherein:
the filtering sub-systems are deployed in at least one location selected from the group consisting of the end user premises, the access network, and the IP core network; and
the at least one location of the filtering sub-systems is selected to collect IPTV traffic with a granularity at the level of the end users;

transmitting the collected IPTV traffic from the filtering sub-systems to a centralized analytic system;

aggregating the collected IPTV traffic in relation to the end users; and

performing business intelligence and marketing oriented analysis over the collected IPTV traffic using the centralized analytic system.

In accordance with another illustrative embodiment, there is provided a system for collecting and analyzing IPTV traffic in an IPTV network including end user premises, an access network, and an IP core network, the system comprising:

filtering sub-systems deployed in at least one location selected from the group consisting of the end user premises, the access network, and the IP core network, the filtering sub-systems each comprising:
a collector in real time of IPTV traffic using at least one access technology, the at least one location being selected to collect IPTV traffic with a granularity at the level of the end users; and
a transmitter of the collected IPTV traffic to a centralized analytic system;

an aggregator of the collected IPTV traffic in relation to each individual end user; and

the centralized analytic system comprising an analytic server structured to perform business intelligence and marketing oriented analysis over the collected IPTV traffic.

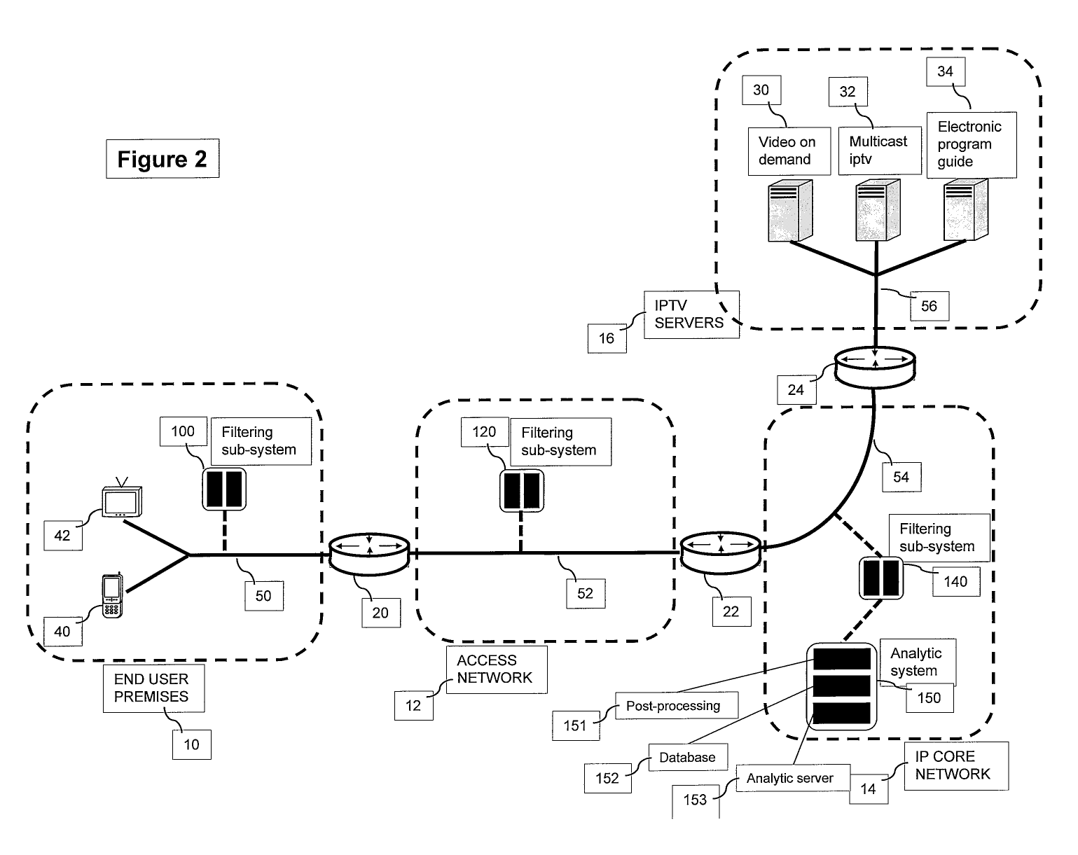

Generally stated, the method and system of FIG. 2, for collecting and analyzing IPTV traffic allow for easy extraction and gathering of IPTV traffic in any type of IP based network. The IPTV traffic may be processed according to the Open Systems Interconnections (OSI) layers to extract different types of pertinent IPTV related data. This data is centralised to an analytic system in order to perform Business Intelligence processing. The resulting output can be aimed at helping Telecom Operators to analyze, improve and develop their marketing and business operations.

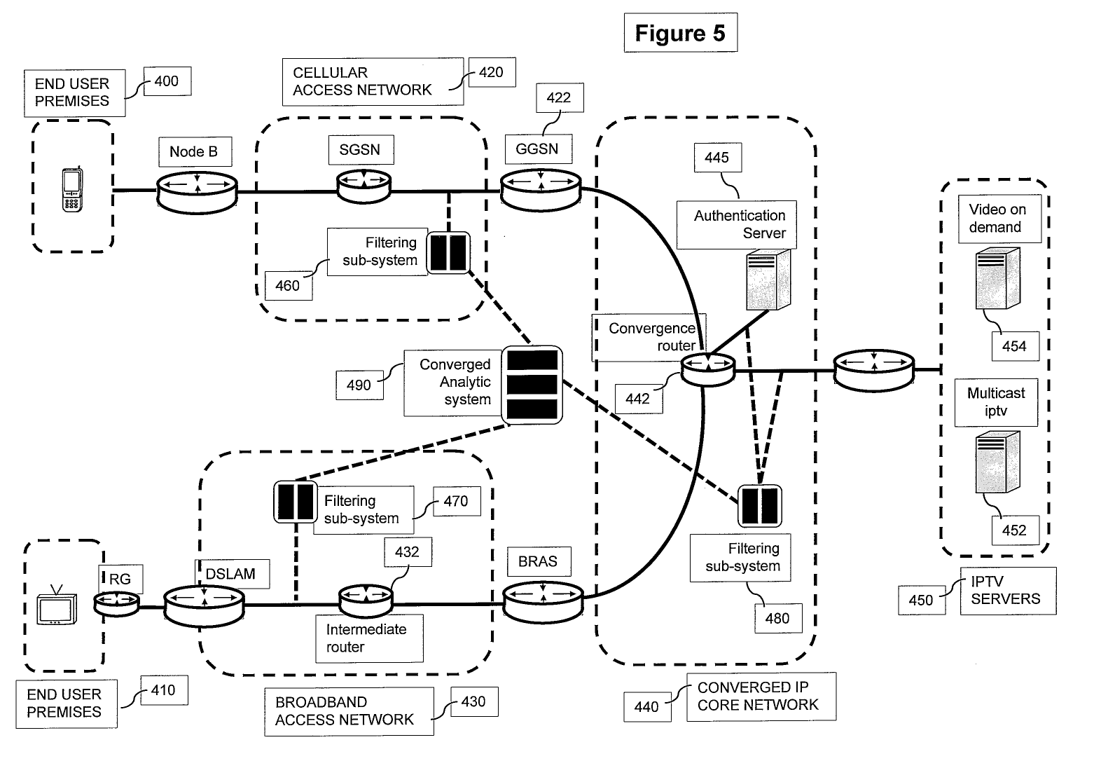

The method and system for collecting and analyzing IPTV traffic enable to extract IPTV traffic at different locations of the IP network, in a distributed manner. Such locations may include, for example but not exclusively, the end user premises, the access network, the IP core network and the IPTV servers. The extracted traffic is processed locally to extract the pertinent IPTV related data, which are then transmitted to the centralized analytic system. Such method and system are highly scalable, since they allow Telecom Operators to perform the IPTV traffic collection at the best location in the network, based on the type of IPTV related data to be extracted. Additionally, the capture of IPTV related data is optimized for a specific access technology, for example cellular or broadband, and even for a specific network architecture within the same type of access technology. In the case of Telecom Operators with a converged IP network based on different access technologies (for example FIG. 5), the method and system for collecting and analyzing the converged IPTV traffic allow to gather IPTV related data for each access technology used to offer ITPV services to the end users.

Also, the method and system for collecting and analyzing IPTV traffic provide to Telecom Operators a real time, or at least near real time view of the IPTV traffic in their IP network. For that purpose:
The analytic system applies different metrics to the IPTV related data, providing Telecom Operators with an accurate view of the end users' behaviour in relation to IPTV services; and
The analytic system performs the Business Intelligence analysis based on the real time IPTV traffic going through the Telecom Operator IP network.

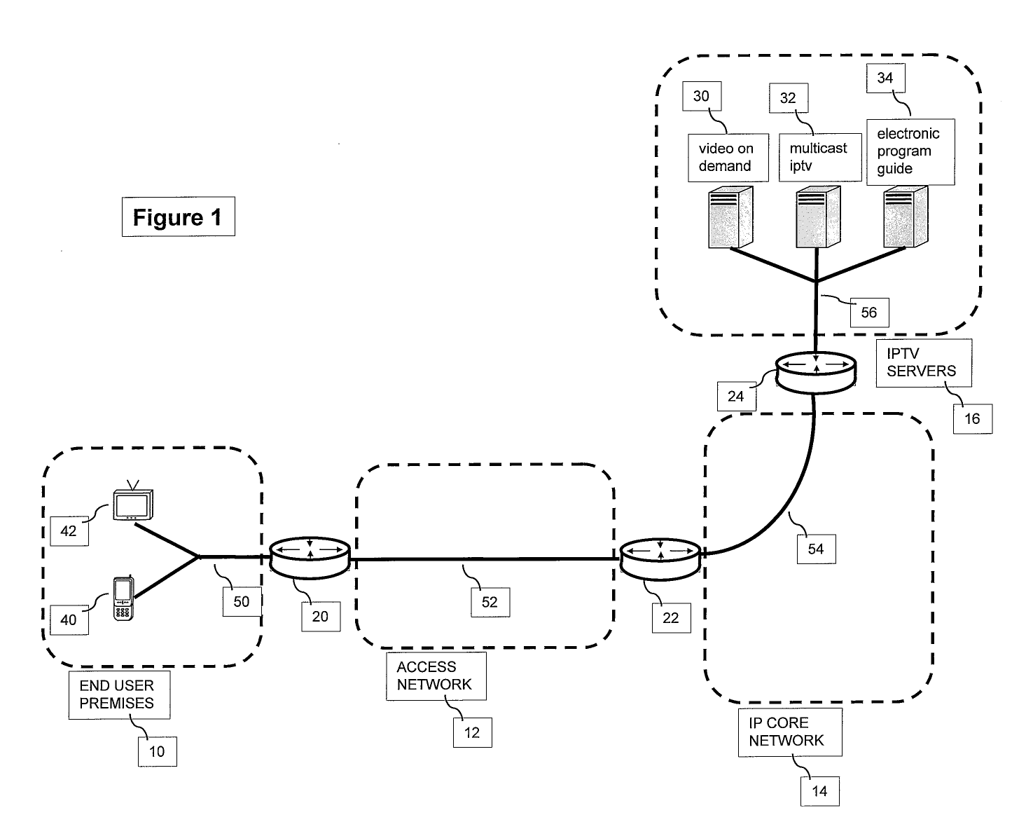

Now, turning to FIG. 1, an infrastructure of IPTV network will be described.

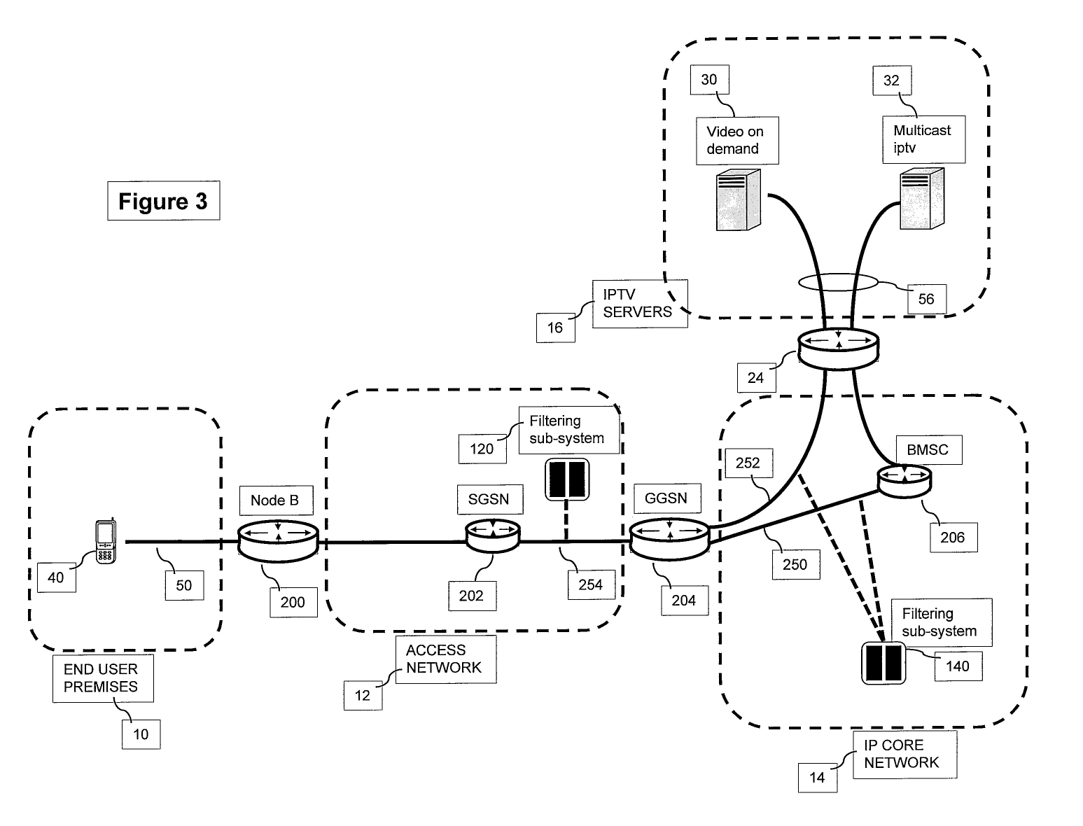

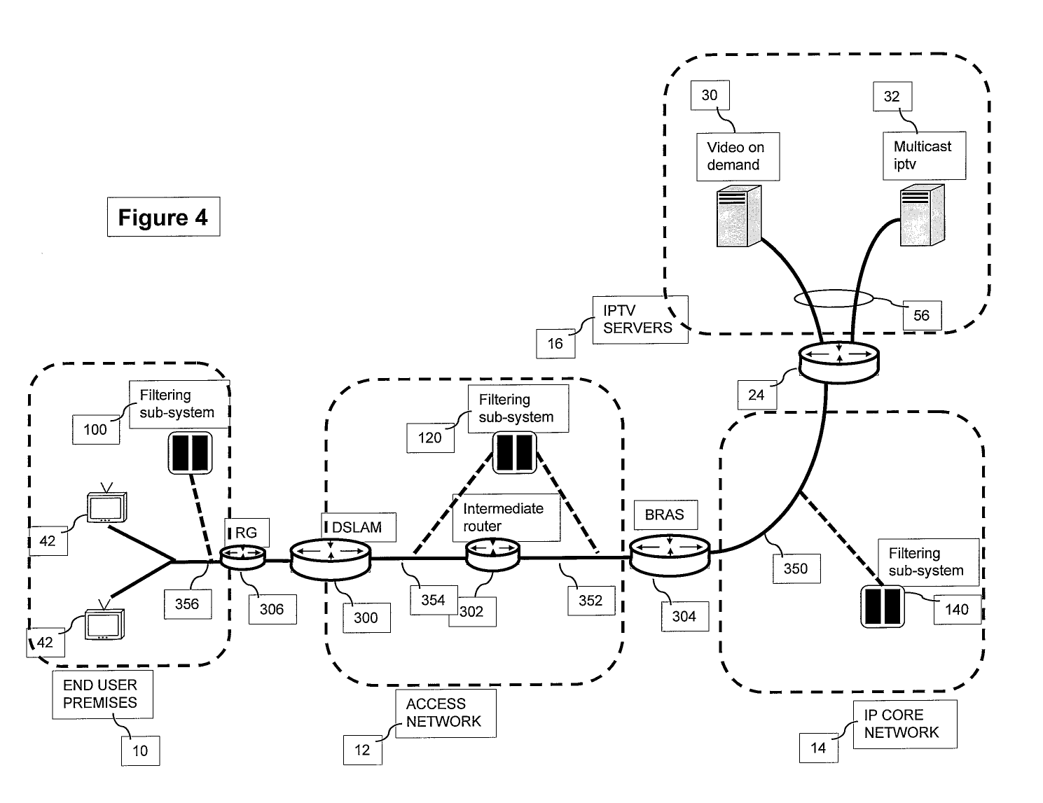

The IPTV network of FIG. 1 comprises end user premises 10. The end user premises 10 may comprise, for example, end user equipments such as a cellular phone or Mobile Internet Device 40 in the case of a Cellular Network or a TV set 42 in the case of a Broadband Network. The IPTV services are received by the end user via the end user equipments 40 and 42. Any type of end user equipments allowing reception, processing and consumption of IPTV services can be used at the end user premises 10. Also, several intermediate IP networking equipments such as, for example, a Set Top Box or a Multimedia Gateway (not shown) in the context of a Broadband Network, may be deployed at the end user premises 10. FIG. 1 illustrates a dedicated IP networking equipment 20, for example a Node B 200 as illustrated in FIG. 3 or a Residential Gateway 306 as illustrated in FIG. 4, to connect the end user equipments 40 and 42 to the access network 12.

The IPTV network of FIG. 1 further includes an access network 12. The architecture of the access network 12 depends on the underlying access technology: cellular network, broadband network (including cable, Digital Subscriber Line (DSL), optical fiber, etc.). FIGS. 3 and 4 illustrate specificities of the access network 12 in the case of cellular (FIG. 3) and broadband (FIG. 4) access technologies. A dedicated IP networking equipment 22, for example a GGSN 204 as illustrated in FIG. 3 or a BRAS 304 as illustrated in FIG. 4, connects the access network 12 to the IP core network 14.

The IPTV network of FIG. 1 still further comprises an IP core network 14. Any type of IP traffic (including IPTV traffic) between the end user equipment 40 or 42, and a peer communicating end point, goes through the IP core network 14. The access network 12 connects to external networks such as the Internet, other Telecom Operator networks, and third party networks via the IP core network 14. The IP core network 14 also provides connectivity to the Telecom Operator services, as well as third party services. A dedicated IP networking equipment 24, for example a generic purpose core IP router potentially optimized for multimedia traffic delivery, connects the IP core network 14 to IPTV servers 16, which represent an instance of the above mentioned Telecom Operator or third party services.

Finally, the IPTV network of FIG. 1 comprises IPTV servers 16. These IPTV servers 16 can be part of the Telecom Operator network, or may be hosted by a third party provider. IPTV servers 16 may include, for example, a Video (or Television) On Demand server 30, a multicast IPTV server 32, an electronic program guide 34, etc. Other types of IPTV servers such as 16 may be deployed as well, to provide additional IPTV services.

The Video (or Television) On Demand server 30 provides unicast video (or television) services to the end users. More specifically, the Video (or Television) On Demand server 30 enables an end user to order to the server 30 through the access 12 and IP core 14 networks, receive from the server 30 through the IP core 14 and access 12 networks, and watch on the end user equipments 40 and 42 any type of video (or television) content stored in the Video (or Television) On Demand server 30 at any time and as many times as requested, with possibilities to stop and resume the viewing.

The multicast IPTV server 32 provides multicast television services to the end users. More specifically, the multicast IPTV server 32 broadcasts TV channels through the IP core 14 and access 12 networks. The end users can select and watch a TV channel from a group of predetermined TV channels on the end user equipment 40 or 42, and instantly change the currently selected and watched TV channel.

The Electronic Program Guide 34 provides a list of available TV channels on the multicast IPTV server 32, and the programs for each TV channel. The equivalent of the Electronic Program Guide 34 for the Video (or Television) On Demand server 30 may be part of the Video (or Television) On Demand server 30 itself, or may deployed as a standalone server, not shown in FIG. 1. The Electronic Program Guide 34 and the equivalent Video (or Television) On Demand guide can be consulted by the end users through the access 12 and IP core 14 networks.

Finally, the IP traffic related to IPTV services is represented by IP flows 50, 52, 54 and 56 in FIG. 1. More specifically, the IP traffic related to IPTV services flows between the end user equipment 40 or 42 and the IPTV servers 16, via the end user premises 10, the access network 12 and the IP core network 14.

FIG. 2 illustrates a method and system for collecting and analyzing IPTV traffic in the infrastructure of an IPTV network as illustrated in FIG. 1.

The method and system for collecting and analyzing IPTV traffic as shown in FIG. 2 can form a distributed system for the IPTV data collection. Such a distributed system may comprise several filtering sub-systems 100, 120 and 140 respectively located in the end user premises 10, in the access network 12, and in the IP core network 14. Such a filtering sub-system may include an IP traffic collector (not shown) capable of collecting in real time a copy of the IP traffic on the target network with no disruption or delay. Such a filtering sub-system may also comprise an IPTV data extractor (not shown), such as a Deep Packet Inspection (DPI) component. Finally, such a filtering sub-system may comprise a transmitter (not shown), to transfer the extracted IPTV data to a centralizing entity.

Whenever it is possible, IPTV traffic shall be collected by the filtering sub-system 140 located in the IP core network 14. In a typical, non limitative deployment, only one to a few such sub-systems would be deployed in the IP core network 14 of a Telecom Operator. For example, in the case of the Video (or Television) On Demand service, IP based protocols being used to deliver the service comprise the Real Time Protocol (RTP), the Real Time Streaming Protocol (RTSP), the Session Description Protocol (SDP), and possibly the Hypertext Transfer Protocol (HTTP). During a Video (or Television) On Demand session between an end user equipment 40 or 42 and the Video (or Television) On Demand server 30, the IP traffic related to this service (RTP, RTSP, SDP, HTTP, etc.) could be collected from the IP flow 50 in the end user premises 10, from the IP flow 52 in the access network 12, or from the IP flow 54 in the IP core network 14. For scalability reasons, it is very convenient to use in this particular case a single (possibly a few) filtering sub-system(s) 140 located in the IP core network 14.

When it is not possible to collect the IPTV traffic in the IP core network 14, it will be collected for example by the filtering sub-system 120 located in the access network 12. In a typical, non limitative deployment, tens to hundreds to thousands of filtering sub-systems such as 120 can be deployed in the access network 12 of a Telecom Operator. The number of filtering sub-systems 120 depends on the underlying access technology and how close to the end-user premises 10 such filtering sub-systems are deployed (FIG. 3 and FIG. 4 will illustrate this issue). For instance, in the case of multicast IPTV service, the multicast IP protocol used to indicate to the multicast IPTV server 32 that an end user has changed the TV channel on the end user equipment 40 or 42 is different in the access network 12 and the IP core network 14. The Internet Group Management Protocol (IGMP) is typically used in the access network 12, while a flavour of the Protocol Independent Multicast (PIM) protocol is used in the IP core network 14. Since the PIM protocol aggregates the IGMP flows (usually in the dedicated IP networking equipment 22), the granularity of the information at the PIM protocol level is not sufficient: it is not possible to identify requests from specific end users. Therefore, it is more accurate to extract the IGMP traffic from the IP flow 52 in the access network 12, via the filtering sub-systems 120. As a result, through the filtering sub-systems 120, it is possible to know exactly which TV channel is viewed by each individual end user.

When it is not possible to collect the IPTV traffic in the IP core network 14 or in the access network 12, it will be collected by the filtering sub-system 100 located in the end user premises 10. In a typical, non limitative deployment, millions of filtering sub-systems such as 100 can be deployed at the end user premises such as 10. Returning to the previous example, the IGMP traffic from the IP flow 52 in the access network 12 may already be aggregated and the granularity at the end user level is lost. This may be the case for a broadband access network, where several end user equipments 40 or 42 in the same end user premises generate their own IGMP traffic. The dedicated IP networking equipment 20 may aggregate these individual IGMP flows for the access network 12. If the Telecom Operator requests a granularity at the level of the various end user equipments 40 or 42 deployed at the end user premises 10, the IGMP traffic is then extracted or collected from the IP flow 50 in the end user premises 10, via the filtering sub-systems 100.

The IPTV data extractors of the filtering sub-systems 100, 120 and 140 extract IPTV related data from the global IP traffic flows 50, 52 and 54, respectively. For that purpose, the IPTV data extractor of the filtering sub-systems 100, 120 and 140 perform analysis on layer 2 to layer 7 of, for example, the OSI model to extract information related to the IPTV services. For the Video (or Television) On Demand service, control traffic is conveyed via the RTSP and SDP protocols, and data traffic is conveyed via the RTP protocol. The HTTP protocol may also be used for control and data traffic. For the multicast IPTV service, the control traffic is conveyed via the IGMP protocol, and the data traffic is conveyed via the multicast RTP protocol. In certain cases (Internet or mobile TV), the IPTV service delivery may not be based on multicast technologies, but may be similar to the Video (or Television) On Demand service, using the RTSP protocol for signaling and the non multicast RTP protocol for data.

The aforementioned protocols represent the most common types of protocols in the context of IPTV services. Any other IP based protocol related to such IPTV services could be supported by the appropriate filtering sub-system 100, 120 or 140. The type of protocols related to the IPTV services and the associated points of capture (filtering sub-systems) will be described with reference to FIGS. 3 and 4, in the case of a cellular network and a broadband network.

The different layers of the IP protocol mentioned in the present disclosure refer to the different layers as defined by the OSI model. The OSI model includes the following seven (7) layers of networking protocols:
Layer 7: application layer;
Layer 6: presentation layer;
Layer 5: session layer;
Layer 4: transport layer;
Layer 3: network layer;
Layer 2: data link layer; and
Layer 1: physical layer.

Although providing a dedicated filtering sub-system (not shown) in the infrastructure of the IPTV servers 16 is technically feasible, this will generally be avoided, to prevent the multiplication of filtering sub-systems at different locations. Only if specific information cannot be captured by the filtering sub-system 140 of the IP core network 14, should a dedicated filtering sub-system be deployed in the infrastructure of the IPTV servers 16.

The IPTV related data gathered at the various filtering sub-systems 100, 120 and 140 are transmitted though their respective transmitters to a centralized analytic system 150. The analytic system 150 comprises a post-processor 151 and a global database 152. The post-processor 151 of the analytic system 150 post-processes and consolidates the IPTV related data to the global database 152, in a pre-defined format consistent with an agreed upon metadata model. Based on the location of a specific filtering sub-system (140 in the core IP network 14, 120 in the access network 12 or 100 in the end user premises 10) and the type of access technology (broadband, cellular, etc.), the type of IPTV related data extracted from the global IP traffic 54, 52 and 50 will widely vary. However, it will always be adapted by the post-processor 151 to fit with the metadata model of the global database 152. Additionally, the post-processor 151 forms an aggregator of the IPTV related data for each individual end user. It will be detailed later in the description how the IPTV related data transmitted by the various filtering sub-systems 100, 120 and 140 can be aggregated in relation to a single global end user identifier.

The location of the analytic system 150 may vary and can be adapted to the needs of the Telecom Operator. In FIG. 2, the analytic system 150 is located in the IP core network 14. The analytic system 150 may also be co-located with the Information System of the Telecom Operator (not shown in FIG. 2). To transfer the IPTV related data to the centralized analytic system 150, the transmitter of each individual filtering sub-system 100, 120 and 140 may directly communicate with the analytic system 150 over the IP protocol. The transmitters of the filtering sub-systems 100 and 120 in the end user premises 10 and the access network 12 may also transfer the IPTV related data to the filtering sub-system 140 in the IP core network 14. The filtering sub-system 140 is then structured to centralize all the IPTV related data, before transferring them to the analytic system 150. Each filtering sub-system 100, 120 and 140 can incorporate its own local memory/database (not shown), where IPTV related data are stored before transmission to the analytic system 150, based on specific events (timer, data volume threshold, etc.). Since the memory/database of the filtering sub-systems 100 (in the end user premises 10) and 120 (in the access network 12) may be limited, it can make sense to use the filtering sub-system 140 (in the IP core network 14) as a centralized intermediate server, with high storage capacity, where raw IPTV related data are temporarily stored, before transmission to the analytic system 150.

In the case of an integrated Telecom Operator with several access networks (broadband, cellular, etc.), a single analytic system 150 can be deployed. This provides the Telecom Operator with a vision of the delivery of converged IPTV services over its global network infrastructure.

Additional information not directly related to the IPTV traffic extracted from the IP flows 50, 52 and 54, may also be obtained by the analytic system 150, or alternatively by the filtering sub-system 140 in the IP core network 14 (in the case where the analytic system 150 is incapable to retrieve such information by itself). For example, the mapping between the different multicast television channels (name of the channels and daily programs) and the IP multicast groups over which they are transmitted by the multicast IPTV server 32 can be obtained directly from the Electronic Program Guide (EPG) 34. For that purpose a connection to the EPG 34 can be established by the filtering sub-system 140 using an appropriate IP based protocol, for example the HTTP protocol, supported by the EPG to retrieve the relevant information. In the particular case of the EPG, the relevant information may be transmitted via a multicast group, in which case the filtering sub-system 140 in the IP core network 14 can extract this information from the global IP flow 54.

The IPTV related data extracted and transmitted by the filtering sub-systems 100, 120 and 140 is analyzed and transformed by the pre-processor 151 of the analytic system 150 to match the metadata model of the global database 152. The following is a non-exhaustive and non-limitative list of the consolidated IPTV data that can be stored in the global database 152.

End user identification: Interaction with a centralized authentication server, for example a Radius Server, is used to match the IP address of the IPTV packets extracted by the filtering sub-systems 100, 120 and 140 with an end user identification, for example the International Mobile Subscriber Identity (IMSI) for a cellular network.

Multicast TV channels watched by an end user and time spent on a specific channel: Interaction with an EPG is used to match the IPTV multicast groups subscribed by an end user (information extracted by the filtering sub-systems 100 or 120 from the IGMP traffic) with corresponding multicast TV channels (information provided by the EPG). Additionally, timestamps associated to the captured data can be used in conjunction with the EPG to identify the specific TV programs watched within the TV channel.

Program watched via the Video (or Television) On Demand service: Detailed information can be extracted and stored: time of watch, number of times the program is watched, start/stop/pause events (information extracted by the filtering sub-systems 140 from the RTSP traffic).

Access technology used for consuming a specific IPTV service: This information is relevant for an integrated Telecom Operator, offering IPTV services over different access technologies (broadband, cellular, etc.). A more or less precise localization in the case of cellular access may be available via additional localization information; for example this may indicate that an IPTV program on a cellular phone is being watched in a train, in a park, in a café, in an airport, etc.

The analytic system 150 further comprises an analytic server 153. An analytic server such as 153 is known as being used for Business Intelligence purpose. More specifically, the analytic server 153 takes as input the large amount of IPTV data stored in the global database 152 and processes this large amount of IPTV data and comprises a generator (not shown) of reports and dashboards adapted to help the Telecom Operator in analyzing the behaviours of the end users related to IPTV service consumption. If the global analytic system 150 is properly dimensioned, it can provide if not real time, “almost” real time feedback to the Telecom Operator. In general, behaviours of the end users can be tracked on a daily, weekly or monthly basis. The following is a non-exhaustive and non-limitative list of information that can be provided by the analytic server 153 to the Telecom Operator.

Audience for a specific TV channel and specific TV programs within a TV channel, with the desired granularity (minutes, seconds): This can help gather accurate statistics on the number of users actually watching advertisements included in a TV program.

Trends in the viewing habits of the end users: For example, news programs are watched at a specific time, followed by a sport program or a movie.

Statistics on Video (or Television) On Demand programs: How many users watch them, when do they watch them, etc.

Level of interaction between the end user and an IPTV program including interactive services or events generated during the program.

Type of device used to access an IPTV service, in the case of an integrated operator: For example TV equipment at home or cellular phone (model and capabilities). The type of access network is also a relevant information in the case of a cellular phone, since the most advanced models include WIFI connections, making it possible to access the IPTV service via the cellular infrastructure, or via a WIFI access point connected to a broadband infrastructure.

Synthesized consumption patterns of an end user consuming converged IPTV services: For example what service, when, where, on what device, etc.

Turning back to the global analytic system 150, such system may include additional features and capabilities not show in FIG. 2, for sake of simplicity. For instance, the global analytic system 150 may be provided with a sophisticated Graphical User Interface, in order to make the reports generated by the generator of the analytic server 153 easier to interpret and use by the Telecom Operator. Also, access to the analytic server 153 itself and to the different types of generated reports, may be controlled by specific authorizations per user or group of users, via an appropriate security mechanism.

The analytic server 153 may also incorporate advanced functionalities. For example, the content of the global database 152 may be transformed according to a specialized data model, optimized for the specific data manipulations performed by the analytic server 153 for Business Intelligence purposes. Also, in addition to the predefined analytic reports, the analytic server 153 may be structured to allow the Telecom Operator to generate customized dynamic reports.

FIG. 3 illustrates an embodiment of the method and system for collecting and analyzing IPTV traffic of FIG. 2, applied to a Cellular Network.

The example of Cellular Network as illustrated in FIG. 3 is a Universal Mobile Telecommunication System (UMTS) network, supporting Multimedia Broadcast Multicast Service (MBMS) for the delivery of multicast IPTV. The use of another cellular technology, such as Code Division Multiple Access 2000 (CDMA2000), is within the scope of the present invention but would have an impact on the nature of the equipments deployed in the access 12 and IP core 14 networks; however, the principles behind the deployments and operations of the filtering sub-systems as described herein after would remain the same.

Referring to FIG. 3, the end user premises 10 are limited to the end user equipments 40, more specifically mobile devices with UMTS capabilities, mainly but non-exclusively cellular phones. The dedicated IP networking equipment 200 connecting the end user premises 10 and the access network 12 is, in this particular case, a Node B. No filtering sub-system is deployed in the end user premises 10 to capture the IP flow 50 between the end user equipment 40 and the Node B 200. It will be explained later why it would not be optimal to use such a filtering sub-system 100 (it would be embedded in the mobile device itself).

In the embodiment of FIG. 3, the access network 12 comprises a Serving GPRS Support Node (SGSN) 202 to handle, in a General Packet Radio Service (GPRS) network, all packet switched data within the network, including the mobility management and authentication of the users. The IPTV data flow 254 in the access network 12 propagates through the SGSN 202. A filtering sub-system 120 is deployed in the access network 12 to capture the IP flow 254 between the SGSN 202 and a Gateway GPRS Support Node (GGSN) 204 responsible, in a GPRS network, for the interworking between the GPRS network and external packet switched networks. The GGSN 204 then forms the dedicated IP networking equipment connecting the access network 12 to the IP core network 14.

A filtering sub-system 140 is deployed in the IP core network 14 to capture the IP flow 250 between the GGSN 204 and a Broadband Multicast Service Center (BMSC) 206. The BMSC 206 is interposed between the GGSN 204 and the dedicated IP networking equipment 24 connecting the IP core network 14 and the IPTV servers 16. The BMSC 206 is a dedicated node deployed in the IP core network 14 to support multicast IPTV services delivered via MBMS. The filtering sub-system 140 also captures the IP flow 252 between the GGSN 204 and the dedicated IP networking equipment 24 connecting the IP core network 14 and the IPTV servers 16.

The data part of the multicast IPTV traffic comprises multicast Real Time Protocol (RTP) IP packets originating from the multicast IPTV server 32 and flowing toward the end user equipment 40 via the BMSC 206, the GGSN 204, the SGSN 202 and the Node B 200. The filtering sub-system 140 captures this IPTV traffic from the IP flow 250 between the BMSC 206 and the GGSN 204—it is referred to as the Gi interface in the Third Generation Partnership Project (3GPP) specifications.

The signalling part of the multicast IPTV traffic comprises Internet Group Management Protocol (IGMP) packets originating from the end user equipment 40 and flowing to the GGSN 204, via the Node B 200 and the SGSN 202. The filtering sub-system 120 captures this traffic from the IP flow 254 between the SGSN 202 and the GGSN 204. The IGMP packets are multicast signaling packets, to subscribe/unsubscribe to the IP multicast groups corresponding to the multicast IPTV channels.

The signalling part of the multicast IPTV traffic also consists in Diameter protocol packets exchanged between the GGSN 204 and the BMSC 206. The filtering sub-system 140 can capture this traffic from the IP flow 250 between the GGSN 204 and the BMSC 206—it is referred to as the Gmb interface in the 3GPP specifications and consists of MBMS specific Attribute-Value Pairs in the Diameter protocol.

The data part and signaling part of the Video (or Television) On Demand IPTV traffic consist in unicast RTP, Real Time Streaming Protocol (RTSP), HTTP, IP packets exchanged between the Video (or Television) On Demand server 30 and the end user equipment 40, via the dedicated IP networking equipment 24 connecting the IP core network 14 and the IPTV servers 16, the GGSN 204, the SGSN 202 and the Node B 200. The filtering sub-system 140 captures this IPTV traffic from the IP flow 252 between the Video On Demand server 30, more specifically the dedicated IP networking equipment 24 connecting the IP core network 14 and the IPTV servers 16, and the GGSN 204—it is referred to as the Gi interface in the Third Generation Partnership Project (3GPP) specifications.

From a deployment perspective, the functionalities of the filtering sub-system 120 may be easily integrated to the filtering sub-system 140, since ultimately all the information present in the IP flow 254 may also be present in the IP flows 250 and/or 252. This is the case if the IPTV multicast signaling traffic (to select multicast IPTV channels) in the IP flow 254 is replicated in the IP flow 250 (potentially via a different signaling protocol). The potential ability, in a Cellular Network, to deploy a single integrated filtering sub-system 140 is a consequence of the scarce radio resources in the cellular access network 12. Resources consuming multimedia services, such as IPTV, are deployed via a centralized architecture to perform admission control, radio resource reservation and user authorization. As a result, all the related IPTV traffic (signalling and data parts) travels through the GGSN 204 and reaches either the BMSC 206 or the dedicated IP networking equipment 24. Thus, it can be captured by the filtering sub-system 140.

FIG. 4 is a schematic diagram of the method and system for collecting and analyzing IPTV traffic of FIG. 2, applied to a Broadband Network.

The Broadband Network as illustrated in FIG. 4 is based on DSL for the access technology. The use of other access technologies, such as cable or fiber, is within the scope of the present invention, but would have an impact on the equipments deployed in the access network 12. However, the principles of the deployments and operations of the filtering sub-systems 100, 120 and 140, as described hereinafter, would remain the same.

The end user premises 10 potentially comprises several end user equipments in the form of TV sets 42, as well as set-top boxes (STBs) not shown in FIG. 4. Computers and dedicated multimedia appliances may be used as well, to consume home IPTV services. A Residential Gateway (RG) 306 connects the end user premises 10 and the access network 12. A filtering sub-system 100 may be optionally deployed in the end user premises 10 to capture the IP flow 356 between the RG 306 and the end user equipments 42.

In the access network 12, a Digital Subscriber Line Access Multiplexer (DSLAM) 300 is interposed between the RG 306 and an intermediate router 302, and the intermediate router 302 is interposed between the DSLAM 300 and a Broadband Remote Access System (BRAS) 304. A filtering sub-system 120 is deployed in the access network 12 to capture the IP flow 354 between the DSLAM 300 and the intermediate router 302 and/or the IP flow 352 between the BRAS 304 and the intermediate router 302. The DSLAM 300 is the dedicated IP networking equipment connecting the access network 12 to the end user premises 10. The BRAS 304 is the dedicated IP networking equipment connecting the access network 12 to the IP core network 14.

A filtering sub-system 140 is deployed in the IP core network 14, to capture the IP flow 350 between the BRAS 304 and the dedicated IP networking equipment 24 connecting the IP core network 14 and the IPTV servers 16.

The data part of the multicast IPTV traffic comprises multicast RTP IP packets originating from the multicast IPTV server 32 and flowing toward the end user equipments 42, via the dedicated IP networking equipment 24 connecting the IP core network 14 and the IPTV servers 16, the BRAS 304, the intermediate router 302, the DSLAM 300 and the RG 306. The filtering sub-system 140 captures the IPTV traffic from the IP flow 350 between the dedicated IP networking equipment 24 and the BRAS 304.

The signaling part of the multicast IPTV traffic comprises IGMP packets originating from the end user equipments 42 and flowing toward the BRAS 304, via the RG 306, the DSLAM 300 and the intermediate router 302. Ideally, the filtering sub-system 120 would capture the IPTV traffic from the IP flow 352, as close as possible from the BRAS 304. However, in certain deployments, the capture is better performed from the IP flow 354, close to the DSLAM 300. In a typical DSL access network, there is one to a few BRAS 304, compared to hundreds to thousands DSLAM 300. Therefore, there is one to a few points of capture of the IP flow 352, compared to hundreds to thousands points of capture of the IP flow 354. An optimization known as IGMP proxying can be performed at the RG 306, DSLAM 300 or intermediate router 302, wherein several incoming IGMP flows are aggregated in a single outgoing IGMP flow, resulting in a loss of granularity in the IGMP flows. It is then no longer possible to differentiate the IGMP flows initiated by individual end user equipments 42. If such an optimization is performed by means of the intermediate router 302, the filtering sub-system 120 captures the IGMP traffic from the IP flow 354, to keep a maximum IGMP granularity. If such an optimization is performed by means of the DSLAM 300 or the RG 306, the filtering sub-system 100 is used to capture the IGMP traffic from the IP flow 356, to keep a maximum IGMP granularity. This illustrates a case in which a filtering sub-system 100 is deployed at the end user premises 10. The filtering sub-system 100 can be a standalone equipment or it can be integrated as a functionality of the RG 306. If no optimization is performed on the IGMP flows, the filtering sub-system 120 can capture the IGMP traffic from the IP flow 352, as close as possible to the BRAS 304.

The data part and signaling part of the Video (or Television) On Demand traffic consist in unicast RTP, RTSP, HTTP, IP packets exchanged between the Video (or Television) On Demand server 30 and the end user equipments 42, via the dedicated IP networking equipment 24 connecting the IP core network 14 and the IPTV servers 16, the BRAS 304, the intermediate router 302, the DSLAM 300 and the RG 306. The filtering sub-system 140 captures this traffic from the IP flow 350 between the Video (or Television) On Demand server 30, more specifically the dedicated IP networking equipment 24 connecting the IP core network 14 and the IPTV servers 16, and the BRAS 304.

The network architectures described in FIGS. 3 and 4 have no major impact on the centralized analytic system 150 shown in FIG. 2. The only requirement is that such an analytic system 150 is capable of handling any type of IPTV related data collected and transmitted to the analytic system 150 by the filtering sub-systems 100, 120 and 140 as described in relation to FIGS. 3 and 4.

The choice of the deployment of the filtering sub-systems 100, 120 and 140 shown in FIGS. 3 and 4 in the end user premises 10, the access network 12, and in the IP core network 14 depends on multiple parameters, including the type of access technology (cellular or broadband), the global network architecture, as well as issues related to cost, scalability and regulations.

Regarding the end user premises 10, for a cellular network (FIG. 3), a filtering sub-system would comprise the cellular phone itself. Considering the variety in cellular phone models and mobile operating systems, it is not realistic to consider developing a generic embedded filtering software or to customize the software for various categories of cellular phones and operating systems. Thus, it is not a realistic option to deploy a filtering sub-system in the end user premises 10 for a cellular network (FIG. 3).

For a broadband network (FIG. 4), deploying a filtering sub-system 100 at the end user premises 10 can be implemented by some Telecom Operators, for instance as an embedded component of a RG or STB. The benefit is that the filtering sub-system 100 is located at a centralized location for the considered end users, making it easy to intercept all IPTV related traffic. However, some regulatory issues related to end user privacy may impose an opt-in process, allowing the deployment of the filtering sub-system 100 at the end user premises 10 only for a sample of all the end users. For those end users who have not opted-in, there is no other choice than using a filtering sub-system 120 in the access network or a filtering sub-system 140 in the IP core network 14 to gather information related to IPTV service consumption by these end users. Issues related to scalability and costs have already been mentioned as well, to justify the deployment of the filtering sub-systems 120 and 140 in the access network 12 and/or IP core network 14, rather than at the end user premises 10.

Regarding the IPTV multicast signaling traffic originating from the end users (for example to select a TV channel), it has already been mentioned that it is aggregated in the access network 12 for a broadband network. Accordingly, it is not possible to collect the IPTV multicast signaling traffic originating from the end users in the IP core network 14. Thus, a filtering sub-system is implemented in the end user premises 10 or in the access network 12 to capture this IPTV multicast signaling traffic. It has also been mentioned previously, in relation to FIG. 4, that the location of the filtering sub-system for extracting this IPTV multicast signaling traffic at the end user premises 10 or in the access network 12 is determined by the specific broadband network topology. In the case of a cellular network, in a general manner, it will be collected by a filtering sub-system in the access network 12.

Regarding the IPTV multicast data traffic originating from the multicast IPTV server 32 and the Video (or Television) On Demand traffic in both directions, the filtering sub-system to capture this type of IPTV traffic can be located in the IP core network 14. Thus, a single instance of the filtering sub-system can be used for that purpose. In the case of a broadband network, it makes sense to use a single powerful filtering sub-system in the IP core network 14 to capture the aforementioned traffic while multiple less powerful and less expensive filtering sub-systems are deployed either in the access network 12 and/or at the end user premises 10 to collect only the traffic that cannot be captured by the filtering sub-system in the IP core network 14, for example the IPTV multicast signaling traffic.

The filtering sub-system in the IP core network 14 is also well suited for capturing general purpose information not related to any specific end user. This is the case of EPG data since it makes no sense to capture the related traffic at various locations in the access network 12; the same information would be duplicated at each filtering sub-system in the access network 12.

One issue with the use of a filtering sub-system in the IP core network 14 is the deployment of NATs/NAPTs (Network Address Translators/Network Address Port Translators) in the access network 12 and/or IP core network 14 of Telecom Operators. The IP address of the end user is generally used to identify a specific data session involving a specific end user, this IP address being correlated to a fixed identifier, like the International Mobile Subscriber Identity (IMSI) in a cellular network, to uniquely identify end users over time—since the IP address usually changes over time for each end user data session. With a NAT/NAPT, the filtering sub-system in the IP core network 14 may see two different end users as having the same IP address, making it impossible to differentiate these two end users.

As illustrated by the previous considerations, many different cases lead to various options for the deployment of filtering sub-systems. The most probable options are the following. For a broadband network, multiple filtering sub-systems in the access network 12 and a filtering sub-system in the IP core network 14. An alternative can comprise multiple filtering sub-systems at the end user premises 10 and a filtering sub-system in the IP core network 14. For a cellular network, multiple (a few units) filtering sub-systems in the access network 12 and a filtering sub-system in the IP core network 14. An alternative, when such an optimization is possible, is to use either multiple filtering sub-systems in the access network 12 only or a single filtering sub-system in the IP core network only.

In the case of an integrated Telecom Operator, with both cellular and broadband access networks, the IPTV services may evolve towards a converged architecture. This is due to the fact that a single IP core network is used to interact with the different types of access technologies. FIG. 5 is a schematic diagram of the method and system of FIG. 2, in which the cellular network of FIG. 3 and the broadband network of FIG. 4 are operated in a converged manner by a single Telecom Operator. The cellular network includes end user premises 400 (the cellular phones) and a cellular access network 420, similar to those described with reference to FIG. 3. The broadband network includes end user premises 410 and a broadband access network 430, similar to those described with reference to FIG. 4. A converged IP core network 440 is shared between the two types of access networks 420 and 430. The converged architecture of FIG. 5 gives access to converged IP data services, including IPTV servers 450. The benefit of the converged architecture of FIG. 5 is that a same multicast IPTV server 452 and Video (or Television) On Demand server 454, forming part of the IPTV servers 450 can be used to deliver IPTV services to both the cellular network and the broadband network.

Considering the deployment illustrated in FIG. 5, the assumption is made that no filtering sub-system is deployed in the cellular end user premises 400 and in the broadband end user premises 410. For instance, it may be forbidden to deploy filtering sub-systems in the broadband end user premises 410 for regulatory issues. Moreover, it may be considered as non optimal in terms of cost, scalability and evolution by the Telecom Operator. Deploying a filtering sub-system in the cellular end user premises 400 (the cellular phones) is not scalable, considering the variety of manufacturers, models, and operating systems. Referring to FIG. 5, a filtering sub-system 460 is deployed in the cellular access network 420 in the same manner as illustrated in FIG. 3, and a filtering sub-system 470 is deployed in the broadband access network 430 in a manner similar as that illustrated in FIG. 4. Both filtering sub-systems 460 and 470 are in charge of capturing IP traffic related to the multicast IPTV server 452 (end user signaling). A filtering sub-system 480 is deployed in the converged IP core network 440 to capture the IP traffic related to the Video On Demand server 454 and to the multicast IPTV server 452 (server data flow). A single converged analytic system 490 receives the information from all the filtering sub-systems 460, 470 and 480.

The assumption is made that the multicast IPTV traffic from the end users (for instance IGMP) to select IPTV channels is aggregated at the level of the GGSN 422 connecting the cellular access network 420 with the converged IP core network 440, and at the level of the intermediate router 432 in the broadband access network 430. For this reason, a dedicated filtering sub-system 460 is also deployed in the cellular access network 420 between the SGSN of that cellular access network 420 and the GGSN 422 and a dedicated filtering sub-system 470 is deployed between the intermediate router 432 of the broadband access network 430 and the DSLAM connecting the end user premises 410 with the broadband access network 430. Beyond the GGSN 422 and the intermediate router 432, the signaling multicast traffic from end users to select channels is aggregated and it is no longer possible to identify individual user requests and to count/analyze them. Thus, the centralized filtering sub-system 480 in the converged IP core network 440 cannot be used for that purpose.

Regarding the IP traffic related to the Video (or Television) On Demand service from/to the Video (or Television) On Demand server 454 forming part of the IPTV servers 450, it goes through a convergence router 442 in the converged IP core network 440. Thus, the filtering sub-system 480 in the converged IP core network 440 captures all the IP traffic related to the Video (or Television) On Demand service, be it related to the cellular access network 420 or to the broadband access network 430. From a technical point of view, the Video (or Television) On Demand traffic may as well be captured in each specific cellular and broadband access networks 420 and 430 by the filtering sub-systems 460 and 470, respectively. However, there are several incentives to use the filtering sub-system 480. One of these incentives is that, in the broadband access network 430, many filtering sub-systems 470 may have to be deployed, as already explained in relation to FIG. 4. Thus, limiting the amount of IPTV traffic being handled by handling only the signaling multicast IPTV traffic constitutes a means to limit the power and cost of the filtering sub-systems 470 to be deployed. Additionally, the Video (or Television) On Demand traffic may be aggregated between the convergence router 442 and the Video (or Television) On Demand server 454, making it easier the identification and capture function of the filtering sub-system 480. Also, a single powerful filtering sub-system 480 can be deployed, instead of increasing the power of multiple filtering sub-systems 460 and 470. Finally, the filtering sub-system 480 takes into account the converged nature of the Video (or Television) On Demand traffic since it handles both the cellular access network 420 and broadband access network 430. The filtering sub-systems 460 and 470 are dedicated to a single access network technology, making it necessary to handle the convergence at another level, for instance in the converged analytic system 490.

The multicast IPTV data flows related to the multicast IPTV service, flowing from the multicast IPTV server 452 forming part of the IPTV servers 450 to the end user premises 400 and 410, are also captured by the filtering sub-system 480 in the converged IP core network 440 (for the same reasons as the Video On Demand IPTV traffic).

The main issue related to the analysis of the converged IPTV services as represented in FIG. 5 is the identification of the end users. In the cellular access network 420, the end users can be identified by their IP addresses and an identifier specific to the cellular network, for example the IMSI. In the broadband access network 430, the end users can be identified by their IP addresses and an identifier specific to the broadband network, for example a broadband user ID used during the authentication process. By matching the information captured by the filtering sub-systems 460 and 470 only, it is not possible to aggregate the IPTV traffic related to the same end user, since the identifiers and the IP addresses are different for the cellular access network 420 and the broadband access network 430. In the converged IP core network 440, a single authentication server 445 is usually deployed, to federate the identification and authentication of the end users when accessing the IPTV services via the various access network technologies. The filtering sub-system 480 monitors this authentication server 445, specifically the authentication requests originating from the cellular access network 420 and the broadband access network 430. Thus, the filtering sub-system 480 is, with the contribution of the authentication server 445, capable of matching the end user's IP address and IMSI specific to the cellular network and the end user's IP address and broadband user ID specific to the broadband network to a global end user identifier; this global identifier may simply be one of the IMSI or the broadband user ID or may be a dedicated identifier. This forms an aggregator (not shown) of any type of IPTV related traffic captured by one of the filtering sub-systems 460, 470 and 480 in relation to the global end user identifier, using one of the mentioned intermediate identifiers, for example IP addresses of end users, IMSIs, broadband user IDs, etc. It should be noted that an authentication server 445 is presented in FIG. 1 for the sake of simplicity. It usually consists of a more generic AAA (Authentication, Authorization and Accounting) server. And any of the related Authentication, Authorization and Accounting IP traffic can be monitored by the filtering sub-system 480, to gather information allowing the identification of the end users over the various access networks via a global end user identifier.

The IP Multimedia Subsystem (IMS) is considered as one of the appropriate technologies for integrated Telecom Operators to operate different access technologies (cellular, broadband, etc.) in a converged manner. It offers an open architecture, based on standardized protocols such as the Session Initiation Protocol (SIP), Diameter, and many others. It also offers an abstraction layer with no regards as to the type of supported access technologies. In this perspective, the IMS presents the potential to become the central point of control for IPTV, Video (or Television) On Demand and related value added interactive services. As a result, most of the IPTV traffic related to IPTV services (control and data) could be captured by a centralized filtering sub-system such as 480 in FIG. 5 located in the converged IP core network 440. The IMS infrastructure can be assimilated to the converged IP core network 440 represented in FIG. 5. For instance, a dedicated equipment, the HSS (Home Subscriber Server), has been specified for the IMS as the central repository for end user identities (and profiles) over various access networks: it replaces the authentication server 445 of FIG. 5. The targeted converged architecture is still under discussion, and the related standardization bodies (3GPP, ETSI, IETF, etc.) have not come up yet with a fully stabilized proposal—specifically when addressing the support of dedicated IP based data services like IPTV or Video (or Television) On Demand over various access technologies.

Several issues have a strong impact on the location of the necessary filtering sub-systems in an IMS infrastructure. For example, the IGMP signaling for IPTV in a broadband network is currently limited to the access network. In the case of an IMS integrated cellular/broadband network, some signaling related to IPTV may go through the IP core network, to allow IPTV to be handled as an IMS converged service. In this case, a single filtering sub-system such as 480 of FIG. 5 in the IP core network could partially or totally replace all the filtering sub-systems such as 470 in FIG. 5, deployed in the broadband access network (at the DSLAM or BRAS level).

The IMS infrastructure also facilitates the deployment of interactive value added services related to IPTV. The signaling protocol for these interactive services can be SIP and the data protocol can be HTTP among others. The signaling and data flows related to these interactive services can be extracted by a filtering sub-system such as 480 of FIG. 5, located in the converged IP core network 440. This is due to the fact than any signaling or data traffic between the end user equipments (end user premises 410 in FIG. 5) and the interactive services IPTV servers such as 450 in FIG. 5, go through the converged IP core network 440 of FIG. 5.

Examples of interactive video services are: presence and chatting with friends directly on TV to share comments on programs, phone calls received directly on TV while watching a channel with calling party identification, interactive TV programs (vote, interaction with TV animator, products purchased directly on TV, etc.). Online Personal Video Recorders can also be considered as an example of such an interactive service. They allow the end user to record its favorite programs on a server located in the Telecom Operator infrastructure, and view them later just like for a Video (or Television) On Demand program.

By matching the data related to pure IPTV services with those related to the associated interactive value added services, the analytic system such as 490 in FIG. 5 has the capability to provide the Telecom Operator with more detailed and accurate information about the end user habits and behaviors related to IPTV services. For example, the impact of an advertising campaign or a new TV program can be better tracked via the associated interactive services offered to the end user.

Although the present invention has been described in the foregoing specification by means of several non-restrictive illustrative embodiments, these illustrative embodiments can be modified at will, within the scope of the appended claims, without departing from the spirit and nature of the subject invention.

1. A method for collecting and analyzing IPTV traffic in an IPTV network, the method comprising:
deploying filtering sub-systems to collect in real time IPTV traffic delivered over at least one access technology, wherein:
for each of said at least one access technology, selecting at least one location from the group consisting of end user premises, an access network, and an IP core network; and
for each of said selected at least one location, deploying a filtering sub-system to collect IPTV traffic with a granularity at end users' level;
transmitting the collected IPTV traffic from the filtering sub-systems to a centralized analytic system;
aggregating the collected IPTV traffic in relation to the end users; and
performing business intelligence and marketing oriented analysis over the collected IPTV traffic using the centralized analytic system.

2. A method for collecting and analyzing IPTV traffic as defined in claim 1, wherein the IPTV traffic comprises at least one of multicast IPTV, Video On Demand, Television On Demand, an electronic program guide, and an interactive television service.

3. A method for collecting and analyzing IPTV traffic as defined in claim 1, wherein the at least one access technology is selected from the group consisting of a cellular network and a broadband network.

4. A method for collecting and analyzing IPTV traffic as defined in claim 1, wherein the end user premises comprise end user equipments selected from the group consisting of, but not limited to, a cellular phone, a mobile internet device, a TV set, a set top box, a computer, and a dedicated multimedia appliance.

5. A method for collecting and analyzing IPTV traffic as defined in claim 1, wherein the at least one location of the filtering sub-systems is selected on the basis of at least one of the following criteria: availability of specific IPTV traffic, scalability of the filtering sub-systems, cost of deployment of the filtering sub-systems, and end users' privacy issues.

6. A method for collecting and analyzing IPTV traffic as defined in claim 1, wherein:
the IPTV traffic is a converged IPTV traffic;
the at least one access technology comprises a plurality of access technologies;
the IP core network is a converged IP core network; and
the access network comprises a plurality of access networks corresponding to the plurality of access technologies, respectively.

7. A method for collecting and analyzing IPTV traffic as defined in claim 6, wherein the converged IP core network is an IMS (IP Multimedia Subsystem) network.

8. A method for collecting and analyzing IPTV traffic as defined in claim 1, comprising collecting, by means of the filtering sub-systems, IPTV traffic in at least one of the following protocols: IGMP, RTSP, unicast and multicast RTP, SIP and HTTP.

9. A method for collecting and analyzing IPTV traffic as defined in claim 1, comprising extracting, by means of the filtering sub-systems and from the IPTV traffic, raw data selected from the group consisting of:
end user identification;
selected TV channels and programs and starting time and duration of watching of the selected TV channels and programs;
watched Video On Demand including start/stop time, duration of view, number of views;
watched Television on Demand including start/stop time, duration of view, number of views;
end user device; and
access technology used.

10. A method for collecting and analyzing IPTV traffic as defined in claim 9, wherein performing business intelligence and marketing oriented analysis comprises generating at least one of the following metrics:
audience of TV channels and programs segmented by end user device and access technology;
audience of Video On Demand programs segmented by end user device and access technology; and
analysis of an influence of a convergence of the access networks to deliver IPTV services by identifying specific consumption patterns.

11. A method for collecting and analyzing IPTV traffic as defined in claim 1, wherein performing business intelligence and marketing oriented analysis comprises:
post-processing the collected IPTV traffic to aggregate raw data from the filtering sub-systems.

12. A method for collecting and analyzing IPTV traffic as defined in claim 11, wherein performing business intelligence and marketing oriented analysis comprises:
storing in a database the aggregated raw data.

13. A method for collecting and analyzing IPTV traffic as defined in claim 12, wherein performing business intelligence and marketing oriented analysis comprises:
performing business intelligence and marketing oriented analysis of the data stored in the database.

14. A method for collecting and analyzing IPTV traffic as defined in claim 1, wherein performing business intelligence and marketing oriented analysis comprises:
generating reports representative of the business intelligence and marketing oriented analysis.

15. A method for collecting and analyzing IPTV traffic as defined in claim 1, wherein deploying filtering sub-systems to collect in real time IPTV traffic comprises:
deploying the filtering sub-systems in the IP core network.

16. A method for collecting and analyzing IPTV traffic as defined in claim 1, wherein deploying filtering sub-systems to collect in real time IPTV traffic comprises:
deploying the filtering sub-systems in the IP core network and in the access network.

17. A method for collecting and analyzing IPTV traffic as defined in claim 1, wherein deploying filtering sub-systems to collect in real time IPTV traffic comprises:
deploying the filtering sub-systems in the IP core network, the access network, and the end user premises.

18. A method for collecting and analyzing IPTV traffic as defined in claim 1, wherein the at least one access technology comprises a cellular network, and wherein deploying filtering sub-systems to collect in real time IPTV traffic comprises:
deploying the filtering sub-systems in the IP core network.

19. A method for collecting and analyzing IPTV traffic as defined in claim 1, wherein the at least one access technology comprises a cellular network, and wherein deploying filtering sub-systems to collect in real time IPTV traffic comprises:
deploying the filtering sub-systems in the IP core network and the access network.

20. A method for collecting and analyzing IPTV traffic as defined in claim 1, wherein the at least one access technology comprises a broadband network, and wherein deploying filtering sub-systems to collect in real time IPTV traffic comprises:
deploying the filtering sub-systems in the IP core network, and in at least one of the access network and the end user premises.

21. A method for collecting and analyzing IPTV traffic as defined in claim 6, wherein:
the IPTV traffic is a converged IPTV traffic;
the IP core network is a converged IP core network; and
the at least one access technology comprises converged cellular and broadband networks, the cellular network comprising an access network and end user premises, and the broadband network comprising an access network and end user premises.

22. A method for collecting and analyzing IPTV traffic as defined in claim 21, wherein deploying filtering sub-systems to collect in real time IPTV traffic comprises:
deploying the filtering sub-systems in the converged IP core network, in the access network of the cellular network, and in at least one of the access network and the end user premises of the broadband network.

23. A method for collecting and analyzing IPTV traffic as defined in claim 21, wherein deploying filtering sub-systems to collect in real time IPTV traffic comprises:
deploying the filtering sub-systems in the converged IP core network.

24. A system for collecting and analyzing IPTV traffic in an IPTV network, the system comprising:
filtering sub-systems for collecting in real time IPTV traffic delivered over at least one access technology; said filtering sub-systems being deployed for each of said at least one access technology in at least one location selected from the group consisting of the end user premises, the access network, and the IP core network; and said filtering sub-systems each comprising:
a collector in real time of IPTV traffic, said at least one location being selected to collect IPTV traffic with a granularity at the end users' level; and
a transmitter of the collected IPTV traffic to a centralized analytic system;
an aggregator of the collected IPTV traffic in relation to each individual end user; and
a centralized analytic system comprising an analytic server structured to perform business intelligence and marketing oriented analysis over the collected IPTV traffic.

25. A system for collecting and analyzing IPTV traffic as defined in claim 24, wherein the IPTV traffic comprises at least one of multicast IPTV, Video On Demand, Television On Demand, an electronic program guide, and an interactive television service.

26. A system for collecting and analyzing IPTV traffic as defined in claim 24, wherein the at least one access technology is selected from the group consisting of a cellular network and a broadband network.

27. A system for collecting and analyzing IPTV traffic as defined in claim 24, wherein the end user premises include end user equipments selected from the group consisting of, but not limited to: a cellular phone, a mobile internet device, a TV set, a set top box, a computer, and a dedicated multimedia appliance.

28. A system for collecting and analyzing IPTV traffic as defined in claim 24, wherein the at least one location of the filtering sub-systems is selected on the basis of at least one of the following criteria: availability of specific IPTV traffic, scalability of the filtering sub-systems, cost of deployment of the filtering sub-systems, and end users' privacy issues.

29. A system for collecting and analyzing IPTV traffic as defined in claim 24, wherein:
the IPTV traffic is converged IPTV traffic;
the at least one access technology comprises a plurality of access technologies;
the IP core network is a converged IP core network; and
the access network comprises a plurality of access networks corresponding to the plurality of access technologies, respectively.

30. A system for collecting and analyzing IPTV traffic as defined in claim 29, wherein the converged IP core network is an IMS (IP Multimedia Subsystem) network.

31. A system for collecting and analyzing IPTV traffic as defined in claim 24, wherein the collector of the filtering sub-systems collects IPTV traffic in at least one of the following protocols: IGMP, RTSP, unicast and multicast RTP, SIP and HTTP.

32. A system for collecting and analyzing IPTV traffic as defined in claim 24, wherein the filtering sub-systems comprise an extractor from the IPTV traffic of raw data selected from the group consisting of:
end user identification;
selected TV channels and programs and starting time and duration of watching of the selected TV channels and programs;
watched Video On Demand including start/stop time, duration of view, number of views;
watched Television On Demand including start/stop time, duration of view, number of views;
end user device; and
access technology used.

33. A system for collecting and analyzing IPTV traffic as defined in claim 32, wherein the centralized analytic system generates at least one of the following metrics:
audience of TV channels and programs segmented by end user device and access technology;
audience of Video On Demand programs segmented by end user device and access technology; and
analysis of an influence of a convergence of the access networks to deliver IPTV services by identifying specific consumption patterns.

34. A system for collecting and analyzing IPTV traffic as defined in claim 24, wherein the centralized analytic system comprises:
a post-processor of the collected IPTV traffic to aggregate raw data from the filtering sub-systems.

35. A system for collecting and analyzing IPTV traffic as defined in claim 34, wherein the centralized analytic system comprises:
a database for storing the aggregated raw data.

36. A system for collecting and analyzing IPTV traffic as defined in claim 35, wherein the analytic server performs business intelligence and marketing oriented analysis of the data stored in the database.

37. A system for collecting and analyzing IPTV traffic as defined in claim 36, wherein the centralized analytic system comprises a generator of reports representative of the business intelligence and marketing oriented analysis performed by the analytic server.

38. A system for collecting and analyzing IPTV traffic as defined in claim 24, wherein the filtering sub-systems are deployed in the IP core network.

39. A system for collecting and analyzing IPTV traffic as defined in claim 24, wherein the filtering sub-systems are deployed in the IP core network and in the access network.

40. A system for collecting and analyzing IPTV traffic as defined in claim 24, wherein the filtering sub-systems are deployed in the IP core network, the access network, and the end user premises.

41. A system for collecting and analyzing IPTV traffic as defined in claim 24, wherein the at least one access technology comprises a cellular network, and wherein the filtering sub-systems are deployed in the IP core network.

42. A system for collecting and analyzing IPTV traffic as defined in claim 24, wherein the at least one access technology comprises a cellular network, and wherein the filtering sub-systems are deployed in the IP core network and the access network.

43. A system for collecting and analyzing IPTV traffic as defined in claim 24, wherein the at least one access technology comprises a broadband network, and wherein the filtering sub-systems are deployed in the IP core network, and in at least one of the access network and the end user premises.

44. A system for collecting and analyzing IPTV traffic as defined in claim 24, wherein:
the IPTV traffic is a converged IPTV traffic;
the IP core network is a converged IP core network; and
the at least one access technology comprises converged cellular and broadband networks, the cellular network comprising an access network and end user premises, and the broadband network comprising an access network and end user premises.

45. A system for collecting and analyzing IPTV traffic as defined in claim 44, wherein the filtering sub-systems are deployed in the converged IP core network, in the access network of the cellular network, and in at least one of the access network and the end user premises of the broadband network.

46. A system for collecting and analyzing IPTV traffic as defined in claim 44, wherein the filtering sub-systems are deployed in the converged IP core network.
